(19) United States
(12) Patent Application Publication
(10) Pub. No.: US 2018/0128421 A1
(43) Pub. Date: May 10, 2018

(54) MICROPHONE STAND MOUNTING CLIP

(71) Applicant: MUSIC Group IP Ltd., Tortola (VG)

(72) Inventors: David Kenneth Hilderman, Victoria (CA); Calvin Ka-Chun Ma, Victoria (CA)

(21) Appl. No.: 15/346,024

(22) Filed: Nov. 8, 2016

(51) Int. Cl. F16M 13/02; F16B 2/22

(52) U.S. Cl. CPC F16M 13/022; F16B 2/22

(57) ABSTRACT

A mounting clip to quickly and easily mount an object onto a microphone stand pole without disassembling the stand or the object; the clip employs strong, flexible flanges that grip a microphone stand pole by bending open when pressed against the pole then snapping back to fit around the pole when twisted into place. The clip supports the weight of the object to be mounted through frictional force and mechanical grip.

### BACKGROUND

### Technical Field

The present disclosure pertains to the mounting of objects to microphone stands and, more particularly, to a rigid, compliant body to which objects can be attached that snaps into place on a microphone stand pole.

### Description of the Related Art

Microphone stand mounts and accessories are commonplace in the music and spoken word performance industry. Most microphone stand mounting devices are designed for use with telescoping pole stands. The devices include an oversized, roughly C or V-shaped receptacle that fits loosely around a microphone stand pole and that relies on adjustable spring or screw tension to secure the mounting device to the pole, in a similar fashion to a C-clamp or bulldog clip. Many form factors are present in the current market, yet all have the disadvantage of a multi-part mounting or gripping system, which can fail due to lost parts, stripped screws, loose springs, or pieces subject to breakage from over-tightening or excessive torque due to the weight of the devices they support.

### BRIEF SUMMARY

The present disclosure is directed to a mounting clip that solves the inherent problems in multi-part microphone stand clips. In accordance with one aspect of the present disclosure, a device is provided that uses a single, highly durable molded piece with flexible gripping flanges to accomplish what is usually achieved through screw or spring tension. The frictional force exerted by the flanges' grip on a microphone stand pole is sufficient to secure devices that would otherwise require a heavy duty clamp. The pole surface area that is in contact with the clip is substantially greater than that of a traditional clamp-style mount because of the shape and size of the gripping flanges. Therefore, the disclosed microphone stand mounting clip achieves grip and stability comparable to mounting systems that are much bulkier, heavier, and less reliable.

In accordance with one aspect of the present disclosure, a molded clip device to mount to a pole-like structure is provided, the device including a body having first and second semi-circular flanges, wherein the flanges are aligned along a first axis and configured to receive and grip the pole-like structure so the pole-like structure is aligned with the first axis, without requiring disassembly of either the pole-like structure or an object to be mounted to the pole-like structure. The first and second flanges are sufficiently flexible to conform to the shape and diameter of the pole-like structure, and are capable of supporting the weight of the object by frictional force and mechanical grip on the pole-like structure.

In accordance with another aspect of the present disclosure, the foregoing device includes a channel between the two flanges that is sized and shaped to act as an insertion groove to receive the pole-like structure, the channel being offset at an angle relative to the first axis to enable the body to be rotated into engagement with the pole-like structure by twisting. Ideally the body is scaled to fit a standard microphone stand pole for the purposes of mounting one or more objects used in music or spoken word performance or recording.

In accordance with another aspect of the present disclosure a device is provided to mount an object to a pole. The device includes a body; a first flange extending from the body and positioned in spaced relationship to the body, the first flange having a terminal end; a second flange extending from the body and positioned in spaced relationship to the body and in spaced alignment with the first flange, the second flange having a terminal, the second flange positioned in alignment with the first flange along a first axis; and a channel formed between the first flange and second flange and having a longitudinal axis that is at an angle to the first axis, the channel sized and shaped to receive the pole and to enable rotation of the first and second flanges into frictional engagement with the pole when the body is rotated in a first direction about a rotational axis that is substantially perpendicular to the longitudinal axis of the channel and the first axis.

In accordance with another aspect of the present disclosure, the body of the foregoing device is capable of attachment to the object by one or more of an adhesive or at least one fastener.

In accordance with a further aspect of the present disclosure, the first flange extends in a first direction and the second flange extends in a second direction that is opposite to the first direction of the first flange.

In accordance with still yet another aspect of the present disclosure, the first and second flanges have an arcuate shape sized and shaped to receive the pole and grip the pole bilaterally, the first and second flanges are sufficiently flexible to conform to the shape and diameter of the pole and are capable of supporting the weight of the object(s) by frictional force and mechanical grip on the pole.

Microphone stand mounted accessories are increasingly prevalent in the music industry, and with the proliferation of smartphones and tablets in addition to purpose-built musical accessories, there is an increasing need for a versatile, lightweight, robust microphone stand mounted clip to support such accessories.

### DESCRIPTION OF THE SEVERAL VIEWS OF THE DRAWINGS

FIG. 1 is an isometric view of a clip front face showing the channel into which the microphone stand pole is fitted in accordance with the present disclosure;

FIG. 2 is an isometric view from the bottom of the clip of FIG. 1 that shows flexible flanges;

FIG. 3 is an isometric view from the top of the clip of FIG. 1 that shows the flexible flanges of FIG. 2 and the microphone stand pole channel;

FIG. 4 is an isometric view from the side of the clip of FIG. 1 that shows the top flange and semi-circular opening that grips the microphone stand pole;

FIG. 5 is an isometric view from the side of the clip of FIG. 1 that shows the bottom flange and semi-circular opening that grips the microphone stand pole;

FIG. 6 is a perspective view of the clip of FIG. 1 fitted to a microphone stand pole with arrows to indicate how the clip is to be rotated into engagement with the pole; and

FIG. 7 illustrates the clip of FIG. 6 rotated into engagement with the pole.

### DETAILED DESCRIPTION

In the following description, certain specific details are set forth in order to provide a thorough understanding of various disclosed implementations. However, one skilled in the relevant scientific techniques will recognize that implementations may be practiced without one or more of these specific details, or with other methods, components, materials, etc. In other instances, well-known structures or components or both associated with microphone stands, telescoping poles, and accessories for mounting to the microphone stand have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations. For ease of reference, similar structures and features will be illustrated and described using the same reference number.

Generally, the present disclosure is an improvement on the aforementioned mounting devices for attaching objects to a microphone stand, particularly a pole or telescoping pole that forms part of the stand. These prior devices, some of which rely on rubber grips and gravitational force provided by the accompanying object or accessory, such as a loudspeaker system, to increase friction with the microphone stand pole. The device of the present disclosure provides an improved design inasmuch as it employs a rigid yet compliant, flexible material that snaps into place, providing superior gripping and increased friction with a smaller mass and volume of material.

A representative implementation of the present disclosure as described herein is directed to a microphone stand mounting clip, including apparatus and methods, for mounting devices relevant to musical or spoken word performance to a microphone stand pole. It is to be understood that other implementations through structural and functional modifications may be made without departing from the scope of the preferred implementation described herein. The representative implementation described and illustrated herein is directed to one preferred implementation of the disclosure for the sake of clarity, not intending to limit the scope of the disclosure and the appended claims.

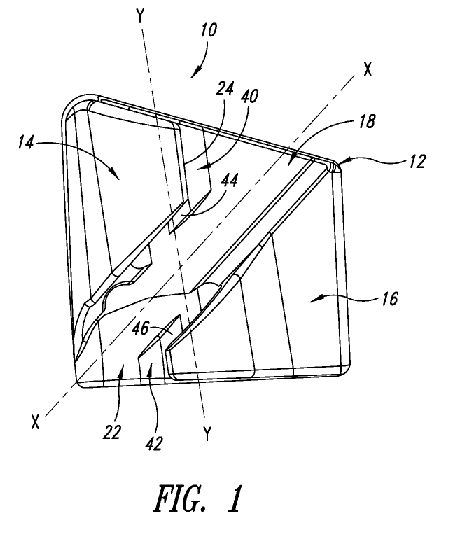

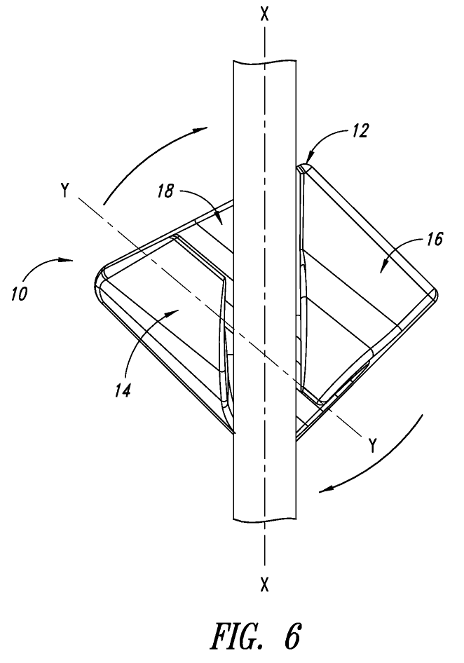

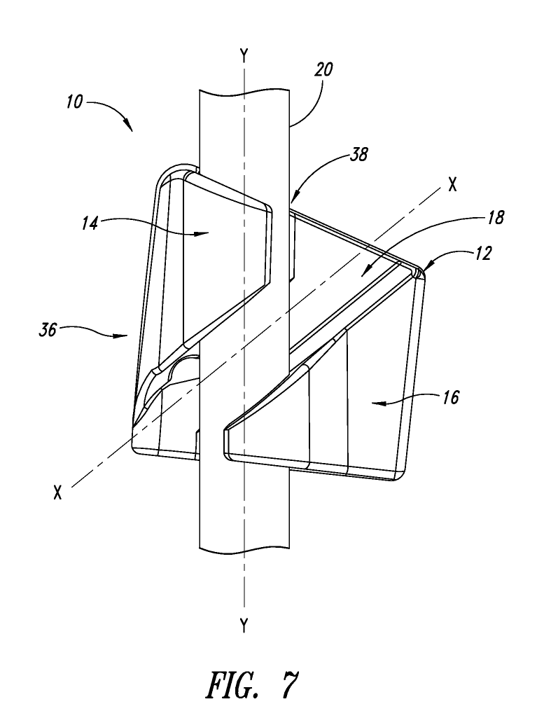

Referring initially to FIGS. 1-5, a microphone stand mounting clip 10 is illustrated to include a body 12 formed of a solid piece of rigid, yet compliant or flexible, material. A first semi-circular gripping flange 14 and a second semi-circular gripping flange 16 extend from the body 12. Ideally they are offset from one another along a first axis Y-Y, as shown here a vertical axis, and oriented to provide an elongate channel 18 between them and having a longitudinal axis X-X into which a microphone stand pole 20 can be slotted and secured (as shown in FIGS. 6 and 7). The arrangement of the flanges 14, 16 and the insertion slot or channel 18 is shown in the front face view of FIG. 1 and the views showing the use of the device on a pole 20 in FIGS. 6 and 7.

The flanges 14, 16 of the clip 10 are arranged such that the channel 18 is sized and shaped to accommodate the microphone stand pole 20 through an opening 22 formed between the two flanges 12, 14, and axis X-X is oriented at an angle relative to the first axis Y-Y. The channel 18 is partially circumscribed by the flanges 14, 16, which allows the clip 10 to be rotated into place on the pole 20, securing the flanges 14, 16 at least partially around the microphone stand pole 20

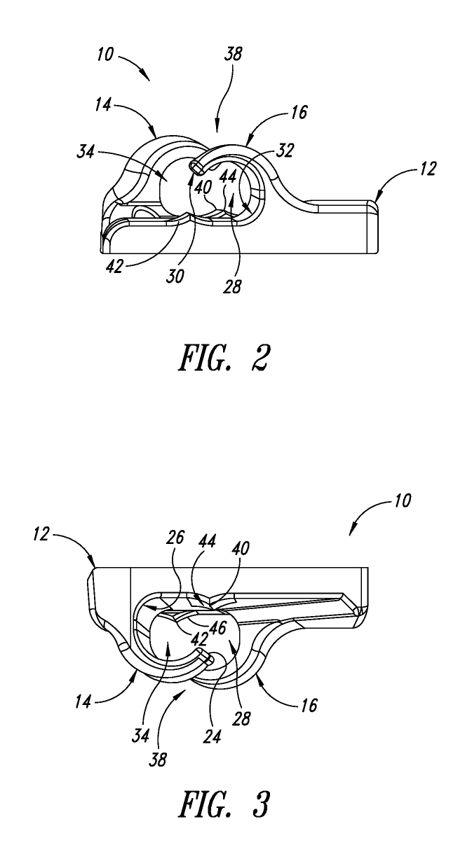

As shown more clearly in FIGS. 2-5, the device 10 includes the body 12 integrally formed with the first flange 14, such as via a molding process, the first flange 14 extending from the body 12 and positioned in spaced relationship to the body 12. The first flange 14 has an arcuate shape with a terminal end 24 that is in spaced relationship to an arcuate slot 26 in the body 12 to form a first semicircular opening 28 sized and shaped to be clamped onto the pole 20. The second flange 16 likewise is ideally integrally formed with and extends from the body 12 and is positioned in spaced relationship to the body 12. The second flange 16 has an arcuate shape with a terminal end 30 that is in spaced relationship to an arcuate slot 32 in the body 12 to form a second semicircular opening 34 sized and shaped to clamp onto the pole 20 as described in more detail below. In addition, the second flange 16 is in spaced alignment with the first flange 14 so that the first and second semicircular openings 28 and 34 cooperate to form a tubular-shaped clamp assembly 36 with a longitudinal bore 38 oriented along longitudinal axis Y-Y that is sized and shaped to receive and securely clamp on to the pole 20 as described more fully below.

More particularly, the channel 18 and the clamp assembly 36 are sized and shaped to receive the pole 20 and to enable rotation of the first and second flanges 14, 16 into frictional engagement with the pole 20 when the body 12 is rotated in a first direction about a rotational axis that is substantially perpendicular to the axis X-X of the channel 18 and the axis Y-Y of the longitudinal bore 38 of the tubular-shaped clamp assembly 36.

To enhance the secure engagement of the device 10 on the pole 20, a first ridge 40 and a second ridge 42 are formed on the body 12. The first and second ridges 40, 42 are formed adjacent the respective first and second semicircular openings 28, 34, and each have a corresponding arcuate face 44, 46 that further defines the size and shape of the longitudinal axial bore 38 of the clamp assembly 36. Ideally the first and second ridges extend into their respective first and second semicircular openings 28, 34 a distance of 1.5 mm, although it can be in the range of 1.0 to 2.0 mm, such as 1.1 mm, 1.2 mm, 1.3 mm, 1.4 mm, 1.6 mm, 1.7 mm, 1.8 mm, 1.9 mm, and 2.0 mm.

In use, the clip 10 is initially pressed against the microphone stand pole 20 with the pole 20 positioned in the channel 18, as shown in FIG. 6. The clip 10 is then rotated clockwise into place by twisting with manual force along the axis perpendicular to the pole 20 in the channel 18. FIGS. 6 and 7 illustrate how the microphone stand pole 20 is slotted between the flanges 14, 16, then rotated into place in the longitudinal bore 38 of the clamp assembly 36 by twisting the microphone stand clip 10.

The flanges 14, 16 are designed with sufficient flexibility to bend around the diameter of a microphone stand pole 20 and have sufficient rigidity to generate strain on the flanges 14, 16 when they are bent. This translates into friction between the flanges 14, 16 and the microphone stand pole 20. The actual radius of the arcuate flanges 14, 16 is smaller than a bending radius that is created when flanges open around the diameter of a microphone stand pole 20 during attachment. Friction by way of strain of the flanges 14, 16 against the microphone stand pole 20 is generated due to the tendency of the flanges 14, 16 to spring back to their actual radius. The flanges 14, 16 initially bend outward away from the body 12 when their terminal ends 24, 30 are initially urged against the microphone stand pole 20 then snap back into position when securely in place around the pole 20.

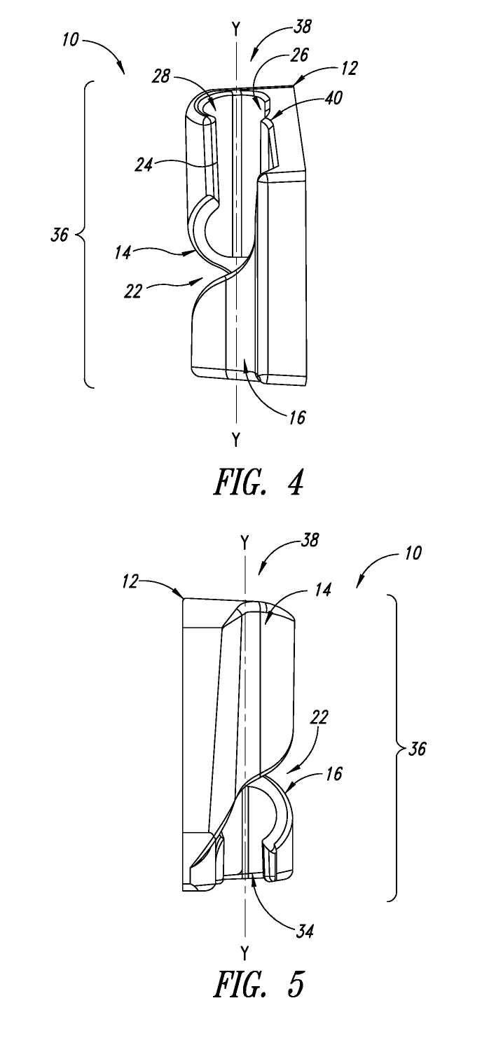

FIG. 4 and FIG. 5 each show the indentations or semi-circular openings 28, 34 created by the respective semi-circular flanges 14, 16 that are sized and shaped to encircle and grip the microphone stand pole 20 from both sides. Bilateral gripping gives additional security to the mounting and resists slipping of the clip 10 and attached object on the pole 20. The pole surface area that is in contact with the clip 10 is substantially greater than that of a traditional clamp-style mount because of the shape and size of the gripping flanges 14, 16. Therefore, the disclosed microphone stand mounting clip 10 achieves comparable grip and stability with mounting systems that are much bulkier, heavier, and less reliable.

The microphone stand mounted clip 10 as depicted may be constructed by injection molding of a thermoplastic material. When used in connection with a pole and an object to be mounted to the pole, the clip 10 forms a mounting system that may be structurally configured to accommodate a variety of brackets, peripherals, or accessory arms to be attached to the clip 10 with fasteners or adhesives or both.

It is possible to employ the system disclosed herein in many applications in which an arbitrary object is to be mounted to a pole-like structure. Arbitrary parameters such as the actual radius and bending radius of the flanges 14, 16, the incident angle of the pole 20, and the orientation and mass of the object to be mounted on the pole 20 with the clip device 10 can be accommodated by changing these parameters to suit the application.

In music industry-specific applications, the clip and system of the present disclosure could be employed to quickly mount: an additional microphone boom or gooseneck, a pad controller or keyboard, a table-top or box for handheld percussion and peripherals, a support stand or holder for a laptop, tablet, or smartphone, inline signal processing equipment, a light onto a lighting truss, or a loudspeaker to a speaker stand or structural frame.

The various implementations described above can be combined to provide further implementations. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A molded clip device to mount to a pole and to hold an object to the pole, comprising:
a body capable of receiving the pole in an open position and engaging the pole in an engagement position, the body including:
first and second semi-circular flanges in spaced relationship with one another and that cooperate to form an elongate channel with a circular cross-sectional configuration having a first axis, the first and second flanges each having a first end extending from the body and a second end that terminates above the body to form first and second access openings between the respective first and second semi-circular flanges and the body; and
an insertion channel formed between the first and second elongate semicircular flanges and having a second axis that is offset at an angle to the first axis, the insertion channel having a size and a shape to receive the pole with the body in the open position and to allow the pole and the body to rotate relative to one another into the engagement position in which the first and second semi-circular flanges resiliently engage the pole with sufficient force to be capable of supporting a weight of the molded clip device and the object by frictional force and mechanical grip on the pole and prevent the molded clip device and the object from moving relative to the pole.

2. The device of claim 1, comprising a first ridge formed on the body and extending into the first access opening to be aliened with the second end of the first semi-circular flange, and a second ridge formed on the body and extending into the second access opening to be aligned with the second semi-circular flange.

3. The device of claim 1, wherein the first and second flanges are in spaced parallel relationship to one another with the access channel formed between them and the first and second access openings facing in opposite directions.

4. The device of claim 2, wherein the body is capable of being secured by fasteners or adhesives to the object such that the device can be mounted securely to the pole.

5. A device to mount an object to a pole, comprising:
a body that is capable of rotation between an open position and a contact position;
a first flange extending from the body to form a first elongate channel between the first flange and the body, the first flange having a terminal end positioned above the body to form a first access opening to the first elongate channel;
a second flange extending from the body to form a second elongate channel between the second flange and the body that is in alignment with the first elongate channel along a first axis, the second flange positioned in spaced parallel relationship to the first flange, the second flange having a terminal end positioned above the body to forma second access opening to the second elongate channel;
a channel formed between the first and second flanges and having a longitudinal axis that is at an angle to the first axis, the channel sized and shaped to receive the pole with the body in the open position and to enable the body and pole to rotate relative to one another to move the pole into frictional engagement with the first and second flanges and to be positioned inside the first and second do/wale channels in the contact position; and
a first ridge formed on the body in alignment with the terminal end of the first flame and a second ridge formed on the body in alignment with the terminal end of the second flange, the first and second ridges extending into the respective first and second openings to secure the pole in the first and second openings when the body is in the contact position and prevent the body from moving relative to the pole.

6. The device of claim 5 wherein the body is capable of attachment to the object by one or more of an adhesive or at least one fastener.

7. The device of claim 5 wherein the first flange extends in a first direction and the second flange extends in a second direction that is opposite to the first direction to provide bilateral gripping on the pole.

8. The device of claim 5 wherein the first and second flanges have an arcuate shape sized to receive the pole and grip the pole, the first and second flanges are sufficiently flexible to conform to a shape and a diameter of the pole and are capable of supporting a weight of the object by frictional force and mechanical grip on the pole.

9. The device of claim 5 wherein the first and second flanges cooperate with the body to form first and second semi-circular openings, the first and second flanges further cooperating with each other and the body to define a clamp assembly having a longitudinal bore formed from respective first and second semi-circular openings that is sized and shaped to receive the pole and provide bilateral gripping of the pole.

10. The device of claim 9, wherein the first and second ridges each have an arcuate side wall that cooperates with the respective first and second flanges to define the longitudinal bore as having a circular cross-sectional configuration.

11. A system, comprising:
a vertical support having a central axis;
a clip that is rotatable relative to the vertical support between an open position and an engagement position, the clip including:
a body having first and second semi-circular flanges with a space therebetween, wherein the first and second semi-circular flanges are aligned along a first axis; and
a channel defined by the space between the first and second flanges and having a second axis that is offset at an angle to the first axis in both the open and the engagement positions, the channel having a size and a shape to receive the vertical support; and
wherein in the open position, the vertical support can be inserted into the channel and the clip can be rotated about the second axis to the engagement position,
wherein in the engagement position, the first axis is aligned with the central axis of the vertical support and each of the first and second flanges contact the vertical support in a friction fit to prevent the clip from moving relative to the vertical support.

12. The system of claim 11 wherein the first flange further includes a first distal end spaced from the body and cooperating with the first flange to define a first semi-circular opening.

13. The system of claim 12 wherein the second flange further includes a second distal end spaced from the body and cooperating with the second flange to define a second semi-circular opening.

14. The system of claim 13, further comprising:
a first ridge formed on the body adjacent to the first semi-circular opening and aligned opposite the first distal end, wherein the first ridge extends from the body into the first semi-circular opening.

15. The system of claim 14, further comprising:
a second ridge formed on the body adjacent to the second semi-circular opening and aligned opposite the second distal end, wherein the second ridge extends from the body into the second semi-circular opening.

16. The system of claim 11 wherein the vertical support is a standard microphone pole.

17. The system of claim 16 wherein the clip is configured to support a weight of an object on the standard microphone pole.
